(19) United States
(12) Patent Application Publication
(10) Pub. No.: US 2025/0110078 A1
(43) Pub. Date: Apr. 3, 2025

(54) GAS SENSOR

(71) Applicant: NITERRA CO., LTD., Nagoya-shi (JP)

(72) Inventors: Masashi NOMURA, Nagoya-shi (JP); Motohiko NAKAMURA, Nagoya-shi (JP)

(73) Assignee: NITERRA CO., LTD., Nagoya-shi (JP)

(21) Appl. No.: 18/899,673

(22) Filed: Sep. 27, 2024

(30) Foreign Application Priority Data
Sep. 29, 2023 (JP) 2023-169330
Jul. 10, 2024 (JP) 2024-110690

(51) Int. Cl. G01N 27/407

(52) U.S. Cl. CPC G01N 27/4077

(57) ABSTRACT

A gas sensor 10 including: a sensor element 21 having electrode pads 21a, 21b at a main surface 20m1, 20m2; metal terminals 71; and a separator 50 having a storage portion 50h in which the rear end side of the sensor element and the metal terminals are stored, an outer casing 46, and a grommet 47, wherein an inner surface of the storage portion has a diameter-expanding portion 50s, the grommet has a grommet hole 47a in which the metal terminals are inserted, a diameter-reducing member 80 for reducing a diameter of the grommet is fitted to an outer periphery on a front end side of the grommet, and the diameter-reducing member is located in a region that is on a front end side relative to a crimping portion 46c formed at the outer casing and overlaps the metal terminals in the grommet in the axial-line direction.

### BACKGROUND

### 1. Field of the Disclosure

The present disclosure relates to a gas sensor suitably used for detecting the gas concentration of a specific gas contained in combustion gas or exhaust gas of a combustor, an internal combustion engine, or the like, for example.

### 2. Description of Related Art

As a gas sensor for detecting the concentration of oxygen or NOx in exhaust gas of an automobile or the like, a gas sensor having a plate-shaped sensor element using a solid electrolyte is known.

As this type of gas sensor, a used one is configured such that a plurality of electrode pads arranged in the width direction are provided on the rear-end sides of opposed main surfaces of a plate-shaped sensor element, and metal terminals electrically contact with the respective electrode pads, to take sensor output signals from the sensor element to outside (Patent Document 1).

In the gas sensor in Patent Document 1, the metal terminals are retained in an insulating connector (separator) of a two-divided type. This connector is configured such that the respective metal terminals are stored in box-type housings having the same shape and the housings are fitted to each other and fixed by a metal clamp. Then, when the rear end side of the sensor element is inserted into an insertion hole of the connector, the metal terminals inside the connector electrically contact with electrode pads.

On the rear end side of the connector, the insertion hole has a diameter expanding radially outward in a direction perpendicular to main surfaces of the sensor element as approaching a rearward-facing surface. Thus, the metal terminals led out to the rear end side of the connector are inhibited from interfering with the inner surface of the connector.
[Patent Document 1] Japanese Patent Application Laid-Open (kokai) No. 2014-209104

### 3. Problem(s) to be Solved

However, when the rear end side of the connector has an expanding diameter, the intervals between the connector and the metal terminals become great, and thus it has been found that the metal terminals sway in the connector due to vibration during usage of the gas sensor or the like and are likely to be broken.

### SUMMARY OF THE DISCLOSURE

An object of the present disclosure is to provide a gas sensor configured to inhibit breakage of metal terminals on the rear end side of a separator.

In one aspect, a gas sensor of the present disclosure includes: a plate-shaped sensor element extending in an axial-line direction and having a plurality of electrode pads at a main surface on a rear end side thereof; a plurality of plate-shaped metal terminals electrically connected to the respective electrode pads; a separator having a storage portion which penetrates in the axial-line direction and in which the rear end side of the sensor element and the metal terminals are stored, thus retaining the metal terminals; an outer casing in which the sensor elements and the separator are stored; and a grommet made of an elastic material and provided on a rear end side of the separator so as to close an opening on a rear end side of the outer casing, wherein an inner surface of the storage portion has a diameter-expanding portion whose diameter expands toward a direction perpendicular to the main surface as approaching a rearward-facing surface of the separator, the grommet has a grommet hole in which rear ends of the metal terminals and lead wires connected to the rear ends are inserted, the plurality of electrode pads and the plurality of metal terminals are arranged separately from each other in a width direction of the sensor element, a diameter-reducing member for reducing a diameter of the grommet at least in a direction perpendicular to the main surface is fitted to an outer periphery on a front end side of the grommet, and the diameter-reducing member is located in a region that is on a front end side relative to a crimping portion formed at the outer casing and fixing the grommet and overlaps the metal terminals in the grommet in the axial-line direction.

The metal terminals have plate shapes, and the plate surfaces face the main surfaces of the sensor element. The plate-shaped metal terminals sway in a direction perpendicular to the plate surfaces. Therefore, due to vibration during usage of the gas sensor or the like, the metal terminals sway radially inward (toward the center side of the sensor element) and are likely to be broken.

Accordingly, with this gas sensor, the grommet hole around the metal terminals may contract radially inward by being pressed by the diameter-reducing member, so that the inner wall of the grommet hole comes close to or into contact with the metal terminals, thus retaining the metal terminals. As a result, sway of the metal terminals in the radially inward direction is inhibited or reduced, whereby breakage of the metal terminals can be inhibited.

In the gas sensor according to the present disclosure, the diameter-reducing member may surround an entire periphery of the grommet.

With this gas sensor, the diameter of the grommet can be assuredly reduced.

In the gas sensor according to the present disclosure, connection portions connected to the lead wires may be provided at the rear ends of the metal terminals, and the diameter-reducing member may be located on a front end side relative to the connection portions.

The connection portions may be thicker than other parts of the metal terminals, for the purpose of retaining the lead wires. Therefore, by the diameter-reducing member reducing the diameter of the grommet at a position away from the connection portions, the diameter of the grommet can be assuredly reduced.

In the gas sensor according to the present disclosure, the diameter-reducing member may extend toward a front end side relative to the grommet.

In a case where the front end of the diameter-reducing member is located on the rear end side relative to the front end of the grommet, the diameter of the front end of the grommet might not be sufficiently reduced. Therefore, by the diameter-reducing member extending toward the front end side relative to the grommet, the diameter of the front end of the grommet can also be assuredly reduced.

In the gas sensor according to the present disclosure, the diameter-reducing member may have, at an inner surface thereof, a taper portion whose diameter expands toward a rear edge, and a straight portion located on a front end side relative to the taper portion, and an inner diameter D1 of the straight portion may be smaller than an outer diameter D2 of the grommet in a state in which the diameter-reducing member is not fitted thereto.

With this gas sensor, the diameter-reducing member can be easily fitted to the grommet, and through the fitting, the straight portion having a smaller diameter than the grommet is press-fitted and thus the grommet and further the grommet hole around the metal terminals can be assuredly contracted, whereby airtightness is improved.

The present disclosure makes it possible to provide a gas sensor configured to inhibit breakage of metal terminals on the rear end side of a separator.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 Sectional view of a gas sensor according to an embodiment of the present disclosure.

FIG. 2 Perspective view showing a separator.

FIG. 3 Sectional view taken along line A-A in FIG. 2.

FIG. 4 Perspective view showing a metal terminal.

FIG. 5 Perspective view of a diameter-reducing member.

FIGS. 6A and 6B Views showing a state in which the diameter-reducing member is fitted from a front end side of a grommet.

### DESCRIPTION OF REFERENCE NUMERALS

Reference numerals used to identify various features in the drawings include, but are not limited to, the following:
10 gas sensor
20 sensor element
20m1, 20m2 main surface of the sensor element
21a, 21b electrode pad
46 outer casing
46c crimping portion
47 grommet
47a grommet hole
48 lead wire
50 separator
50h storage portion
50s diameter-expanding portion
71 metal terminal
80 diameter-reducing member
80t taper portion
80s straight portion
O axial line
F direction perpendicular to the main surface

### DETAILED DESCRIPTION

Hereinafter, embodiments of the present disclosure will be described with reference to the drawings.

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

If used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus ≤10% of particular term, and “substantially” and “significantly” will mean plus or minus >10% of the particular term.

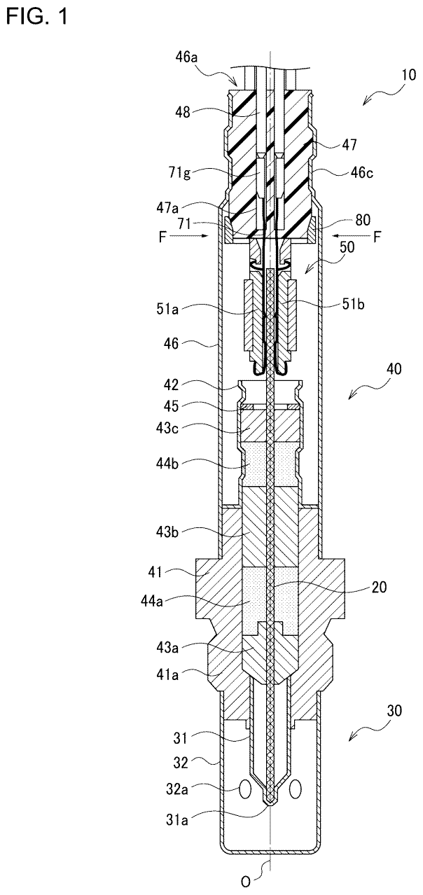

First, with reference to FIG. 1 to FIG. 6, a gas sensor 10 according to an embodiment of the present disclosure will be described.

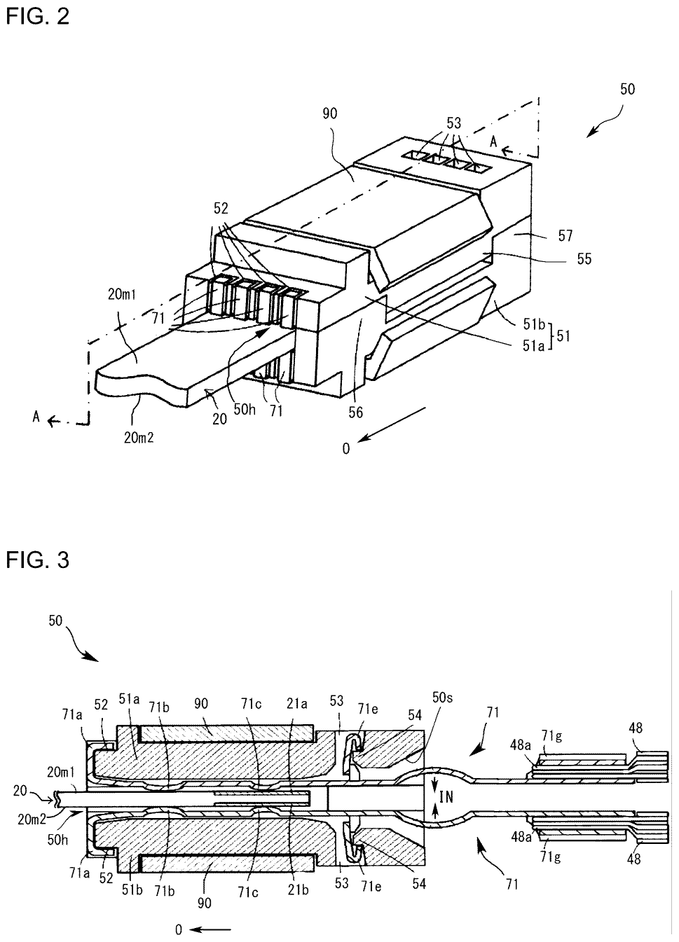

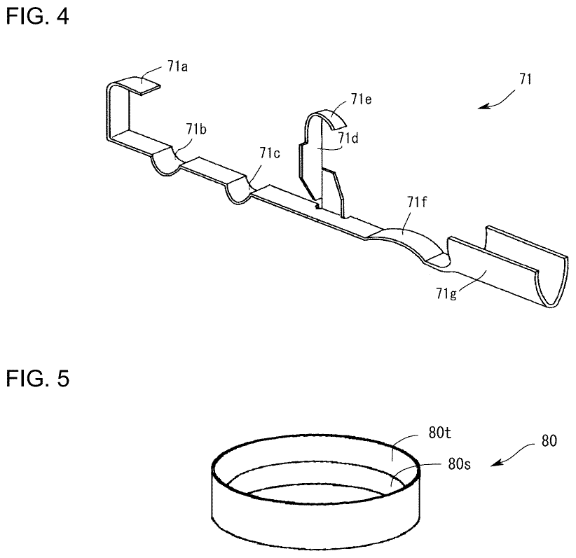

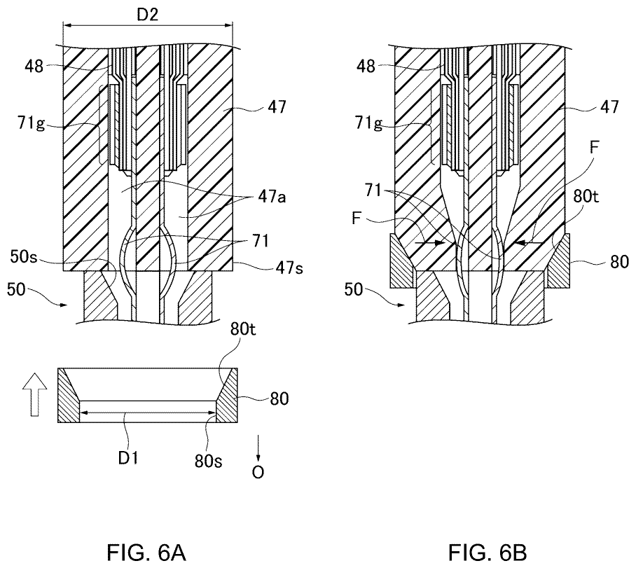

FIG. 1 is a sectional view along the axial-line O direction of a gas sensor (sensor) 10 according to an embodiment of the present disclosure. FIG. 2 is a perspective view showing a separator 50. FIG. 3 is a sectional view taken along line A-A in FIG. 2. FIG. 4 is a perspective view showing a metal terminal 71. FIG. 5 is a perspective view of a diameter-reducing member 80. FIG. 6 is a view showing a state in which the diameter-reducing member 80 is fitted from a front end side of a grommet 47.

FIG. 2 and FIG. 3 show states before the grommet 47 is provided.

As shown in FIG. 1, the gas sensor 10 includes a sensor element 20 which measures a specific gas component in a measurement target gas, a protector 30 for protecting a front end of the sensor element 20, and a sensor assembly 40 including the separator 50 which stores the rear end side of the sensor element 20. The gas sensor 10 is, for example, attached to an exhaust pipe of a vehicle and is used for measuring a gas component such as NOx or O₂ contained in the measurement target gas (exhaust gas).

The sensor element 20 is a plate-shaped element having a long thin size and extending in the axial-line-O direction, and is formed by laminating layers such as a ceramic substrate made of an oxygen ion conductive solid electrolyte layer of zirconia (ZrO₂) or the like. An end on the protector 30 side of the sensor element 20 is referred to as a front end, and an end on the separator 50 side of the sensor element 20 is referred to as a rear end.

A plurality of electrode pads 21a, 21b (FIG. 3) are formed at main surfaces 20m1, 20m2 (FIG. 2 and FIG. 3) on the rear end side of the sensor element 20.

Specifically, as shown in FIG. 3, at one main surface 20m1 of the sensor element 20, the plurality of electrode pads 21a are arranged separately from each other in the width direction of the sensor element 20, and similarly, at the other main surface 20m2 of the sensor element 20, the plurality of electrode pads 21b are arranged separately from each other in the width direction of the sensor element 20.

The plurality of electrode pads may be arranged at only one main surface 20m1 or 20m2 of the sensor element 20.

The electrode pads 21a, 21b are used for applying voltage to the sensor element 20, for outputting detection signals of the sensor element 20, or for energizing a heater in a case where the sensor element 20 has a heater.

As shown in FIG. 1, the protector 30 is provided so as to surround the front end of the sensor element 20. The protector 30 includes an inner protector 31 covering the front end of the sensor element 20, and an outer protector 32 covering the inner protector 31. The inner protector 31 is formed in a tubular shape and has, at the front end of the sensor element 20, an inner gas introduction hole 31a through which the measurement target gas is introduced. The outer protector 32 is formed in a bottomed tubular shape and has, in a side surface, outer gas introduction holes 32a through which the measurement target gas is introduced. The inner protector 31 and the outer protector 32 are made of metal such as SUS, for example.

The sensor assembly 40 includes a metal shell 41 made of metal, an inner casing 42 and an outer casing 46 having cylindrical shapes and welded and fixed to the metal shell 41, and the separator 50 connected to the rear end of the sensor element 20.

The metal shell 41 is attached to, for example, an exhaust pipe of a vehicle, via an external thread part 41a. Inside the inner casing 42, a plurality of ceramic sleeves 43a to 43c, and powder filled layers 44a, 44b such as talc provided between the ceramic sleeves 43a, 43b and between the ceramic sleeves 43b, 43c, are sealed in a state of being held between a metal ring 45 and an inner wall of the metal shell 41.

The outer casing 46 covers the inner casing 42, the sensor element 20, and the separator 50. An opening of the rear end side of the outer casing 46 is closed by a grommet 47 made of rubber. A lead wire 48 is connected to a connection portion 71g (FIG. 4) on the rear end side of the metal terminal 71 by crimping or the like, and the lead wire 48 passes through a grommet hole 47a penetrating the grommet 47 in the axial-line-O direction, so as to be led to the outside from the rear end of the grommet 47.

In the grommet hole 47a, the connection portion 71g of the metal terminal 71 and the lead wire 48 are inserted.

Next, the separator 50 will be described. As shown in FIG. 2, the separator 50 includes a first member 51a and a second member 51b made of ceramic such as an alumina sintered body, and a clamp 90 which may be made of metal and which clamps and fixes the first member 51a and the second member 51b.

Each metal terminal 71 is retained at the first member 51a or the second member 51b, and the metal terminals 71 are arranged so as to contact with the electrode pads 21a, 21b of the sensor element 20 in a one-to-one opposed manner.

At each of the first member 51a and the second member 51b, four metal terminals 71 are retained so as to be arranged in the width direction perpendicular to the longitudinal direction (=axial-line-O direction) of the metal terminals 71. The first member 51a and the second member 51b have the same box-type shape, and therefore the same components thereof are denoted by the same reference characters in the description. The first member 51a and the second member 51b are collectively referred to as a housing 51.

The housing 51 includes a storage portion 50h penetrating in the axial-line-O direction, four engagement grooves 52 with which the front end sides of the metal terminals 71 are engaged, four insertion holes 53 into which erected portions 71d at center parts of the metal terminals 71 are inserted, and engagement portions 54 which are formed in the insertion holes 53 and with which the metal terminals 71 are engaged.

The housing 51 has a projection 55 at a side surface on one side in the width direction across the sensor element 20, and has, at the other side surface, restriction members 56, 57 for restricting the thickness-direction distance between the first member 51a and the second member 51b (see FIG. 2). The projection 55 is inserted into a recess between the restriction member 56 and the restriction member 57 of the housing 51 on the opposite side, thus restricting the positions of the first member 51a and the second member 51b in the thickness direction relative to each other.

As shown in FIG. 4, the metal terminal 71 is a member made of metal and retained by the housing 51 at a position one-to-one opposed to each electrode pad 21a, 21b of the sensor element 20, and has a front end 71a having a bent shape to be engaged with the engagement groove 52, a protrusion 71b bent and protruding toward the sensor element 20, a contact portion 71c bent and protruding toward the sensor element 20 so as to contact with each electrode pad 21a, 21b, the erected portion 71d to be inserted into the insertion hole 53, a bent portion 71f to be led to the outside of the separator 50, and the connection portion 71g to which a plurality of wire elements 48a of the lead wire 48 are crimped and retained outside the separator 50.

The protrusion 71b and the contact portion 71c are arranged along the longitudinal direction of the metal terminal 71, and the contact portion 71c is located closer to the connection portion 71g than the protrusion 71b is. The protrusion 71b and the contact portion 71c are formed to be elastically deformable. The erected portion 71d has an engagement portion 71e having a bent shape to be engaged with the engagement portion 54.

The contact portion 71c of the metal terminal 71 retained at the first member 51a contacts with the electrode pad 21a of the sensor element 20 in a one-to-one opposed manner, and the contact portion 71c of the metal terminal 71 retained at the second member 51b contacts with the electrode pad 21b of the sensor element 20 in a one-to-one opposed manner (FIG. 3).

On the other hand, as shown in FIG. 3, the electrode pads 21a, 21b are formed over a range from the rear end of the sensor element 20 to a position between the contact portion 71c and the protrusion 71b.

As shown in FIG. 2, the clamp 90 is formed by bending a plate-shaped metal, and has an elastic force that can press the first member 51a and the second member 51b in directions to approach each other while clamping them. When the first member 51a and the second member 51b are clamped with the elastic force, the restriction members 56, 57 of the first member 51a contact with the second member 51b, and the restriction members 56, 57 of the second member 51b contact with the first member 51a. Thus, the distance between the first member 51a and the second member 51b is fixed.

When the clamp 90 clamps the first member 51a and the second member 51b in a state in which the sensor element 20 and the metal terminals 71 are sandwiched between the first member 51a and the second member 51b such that the contact portions 71c of the metal terminals 71 are opposed to the electrode pads 21a, 21b of the sensor element 20, the protrusions 71b and the contact portions 71c are elastically deformed by the pressing force from the clamp 90, so that the sensor element 20 is held therebetween and fixed.

At this time, since the elastically deformed protrusion 71b and contact portion 71c press the sensor element 20, the sensor element 20 can be assuredly held therebetween and fixed. In addition, since the contact portion 71c is elastically deformed, electric contact between the contact portion 71c and each electrode pad 21a, 21b can be assuredly kept.

Next, features of the present disclosure will be described.

First, as shown in FIG. 3, the separator 50 includes the storage portion 50h penetrating in the axial-line-O direction, and the storage portion 50h stores the rear end side of the sensor element 20 and the metal terminals 71.

More specifically, the storage portion 50h has, at the front end surface of the housing 51, a rectangular opening slightly larger than the outer shape of the sensor element 20, and communicates with the insertion holes 53 on the rear end side. The storage portion 50h may be an insertion hole having openings only at the front end and the rear end of the housing 51.

In this example, the storage portion 50h is formed by recessing parts of the opposed surfaces of the first member 51a and the second member 51b.

Further, an inner surface of the storage portion 50h has a diameter-expanding portion 50s whose diameter expands toward a direction (up-down direction in FIG. 3) perpendicular to the two main surfaces 20m1, 20m2 of the sensor element 20 as approaching the rearward-facing surface of the separator 50.

The wording “expanding toward the direction perpendicular to the main surfaces 20m1, 20m2” means that the expanding direction has a direction component perpendicular to the main surfaces 20m1, 20m2, and includes a case where the degree of diameter expansion of the diameter-expanding portion 50s is different among locations. Examples include a case where the diameter-expanding portion 50s is not parallel to the main surfaces 20m1, 20m2, a case where the diameter-expanding portion 50s has a curved surface, and a case where the diameter-expanding portion 50s is parallel to the main surfaces 20m1, 20m2 but the front edge or the rear edge of the diameter-expanding portion 50s is not parallel to the main surfaces 20m1, 20m2 (lengths or positions of segments appearing when the diameter-expanding portion 50s is cut along the main surfaces 20m1, 20m2 are different from each other).

The metal terminals 71 have plate shapes and the plate surfaces face the main surfaces 20m1, 20m2 of the sensor element 20. The plate-shaped metal terminals 71 sway in a direction perpendicular to the plate surfaces. Therefore, due to vibration during usage of the gas sensor 10 or the like, the metal terminals 71 sway radially inward (toward the center side of the sensor element 20, i.e., IN direction in FIG. 3) and are likely to be broken.

Accordingly, as shown in FIG. 1, the diameter-reducing member 80 for reducing the diameter of the grommet 47 at least in a direction F perpendicular to the main surfaces 20m1, 20m2 of the sensor element 20 is fitted to an outer periphery on the front end side of the grommet 47.

The diameter-reducing member 80 is located in a region that is on the front end side relative to a crimping portion 46c formed at the outer casing 46 and fixing the grommet 47 and overlaps the metal terminals 71 in the grommet 47 in the axial-line-O direction.

Thus, the grommet hole 47a around the metal terminals 71 contracts radially inward by being pressed by the diameter-reducing member 80, so that the inner wall of the grommet hole 47a comes close to or into contact with the metal terminals 71, thus retaining the metal terminals 71. As a result, sway of the metal terminals 71 in the radially inward direction (IN direction in FIG. 3) is inhibited or reduced, whereby breakage of the metal terminals 71 can be inhibited. Stated differently, the inner wall of the grommet hole comes close to or into contact with the metal terminals so as to inhibit or reduce sway of the metal terminals in the radially inward direction.

Here, in an example shown in FIG. 5, the diameter-reducing member 80 is formed by a metal ring of SUS304 or the like, and has, at an inner surface on the rear end side, a taper portion 80t whose diameter expands toward the rear edge. Of the diameter-reducing member 80, an inner surface on the front end side relative to the taper portion 80t is a straight portion 80s.

As shown in FIGS. 6A & 6B, with respect to a half-completed sensor assembly unit (an assembly unit in which the grommet 47, the separator 50, the metal terminals 71, and the lead wires 48 are assembled and to which the outer casing 46 has not been attached yet), the diameter-reducing member 80 is fitted to the grommet 47 from the front end side (FIG. 6A).

Here, an inner diameter D1 of the straight portion 80s of the diameter-reducing member 80 is smaller than an outer diameter D2 of the grommet 47 in a non-compressed state (in a state in which the diameter-reducing member 80 is not fitted).

The diameter-reducing member 80 is fitted to a front end 47s of the grommet 47 from the taper portion 80t side and then is further pushed toward the rear end, whereby the straight portion 80s having a smaller diameter than the grommet 47 is press-fitted and thus the grommet 47 and further the grommet hole 47a around the metal terminals 71 are contracted radially inward (FIG. 6B).

Then, the assembly unit is stored in the outer casing 46, and the outer casing 46 is crimped on the outer side of the grommet 47, to form the crimping portion 46c.

Whether or not the diameter of the grommet 47 has been reduced by the diameter-reducing member 80 is confirmed as follows. After the outer casing 46 is detached from the grommet 47, the diameter-reducing member 80 is detached, and then if the outer diameter D2 of the grommet 47 near the diameter-reducing member 80 is greater than the minimum inner diameter D1 of the diameter-reducing member 80 that was in contact with the grommet, it is determined that the diameter of the grommet 47 has been reduced.

The diameter-reducing member 80 may be made of metal such as SUS304. The hardness of the diameter-reducing member 80 is preferably 200 HV or greater.

The diameter-reducing member 80 is not limited to a ring shape and may have a C shape, a clip shape, or the like. However, the diameter-reducing member 80 having a ring shape surrounding the entire periphery of the grommet 47 can assuredly reduce the diameter of the grommet 47 and therefore is preferable.

As shown in FIG. 6B, the connection portions 71g connected to the lead wires 48 may be provided at the rear ends of the metal terminals 71, and the diameter-reducing member 80 may be located on the front end side relative to the connection portions 71g.

The connection portions 71g are thicker than other parts of the metal terminals 71, for the purpose of retaining the lead wires 48. Therefore, by the diameter-reducing member 80 reducing the diameter of the grommet 47 at a position away from the connection portions 71g, the diameter of the grommet 47 can be assuredly reduced.

As shown in FIG. 6B, the diameter-reducing member 80 may extend toward the front end side relative to the grommet 47.

In a case where the front end of the diameter-reducing member 80 is located on the rear end side relative to the front end of the grommet 47, the diameter of the front end of the grommet 47 might not be sufficiently reduced. Therefore, by the diameter-reducing member 80 extending toward the front end side relative to the grommet 47, the diameter of the front end of the grommet 47 can also be assuredly reduced.

The present disclosure is not limited to the above embodiments and includes various modifications and equivalents encompassed in the idea and the scope of the present disclosure.

The diameter-reducing member is not limited to the member having the taper portion as described above. Instead, a ring having a larger diameter than the grommet may be fitted to the grommet and then the diameter of the ring may be reduced.

The separator is not limited to the two-divided box shape and may be a tubular shape such as a cylindrical shape.

The diameter-reducing member may reduce the diameter of the grommet at least in a direction perpendicular to the main surface of the sensor element, and for example, with the diameter-reducing member formed in a ring shape, the diameter of the grommet may be reduced also in a direction other than the direction toward the main surface.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2023-169330 filed Sep. 29, 2023 and Japanese Patent Application No. 2024-110690 filed Jul. 10, 2024, the disclosures of which are incorporated herein by reference their entirety.

What is claimed is:

1. A gas sensor comprising:
a plate-shaped sensor element extending in an axial-line direction and having a plurality of electrode pads at a main surface on a rear end side thereof;
a plurality of plate-shaped metal terminals electrically connected to the respective electrode pads;
a separator having a storage portion which penetrates the separator in the axial-line direction and in which the rear end side of the sensor element and the metal terminals are stored, thus retaining the metal terminals;
an outer casing in which the sensor elements and the separator are stored; and
a grommet made of an elastic material and provided on a rear end side of the separator so as to close an opening on a rear end side of the outer casing, wherein
an inner surface of the storage portion has a diameter-expanding portion whose diameter expands toward a direction perpendicular to the main surface as approaching a rearward-facing surface of the separator,
the grommet has a grommet hole in which rear ends of the metal terminals and lead wires connected to the rear ends are inserted,
the plurality of electrode pads and the plurality of metal terminals are arranged separately from each other in a width direction of the sensor element,
a diameter-reducing member for reducing a diameter of the grommet at least in a direction perpendicular to the main surface is fitted to an outer periphery on a front end side of the grommet, and
the diameter-reducing member is located in a region that is on a front end side relative to a crimping portion formed at the outer casing and fixing the grommet and overlaps the metal terminals in the grommet in the axial-line direction.

2. The gas sensor according to claim 1, wherein
the diameter-reducing member surrounds an entire periphery of the grommet.

3. The gas sensor according to claim 1, wherein
connection portions connected to the lead wires are provided at the rear ends of the metal terminals, and
the diameter-reducing member is located on a front end side relative to the connection portions.

4. The gas sensor according to claim 2, wherein
connection portions connected to the lead wires are provided at the rear ends of the metal terminals, and
the diameter-reducing member is located on a front end side relative to the connection portions.

5. The gas sensor according to claim 1, wherein
the diameter-reducing member extends toward a front end side relative to the grommet.

6. The gas sensor according to claim 2, wherein
the diameter-reducing member extends toward a front end side relative to the grommet.

7. The gas sensor according to claim 1, wherein
the diameter-reducing member has, at an inner surface thereof, a taper portion whose diameter expands toward a rear edge, and a straight portion located on a front end side relative to the taper portion, and
an inner diameter D1 of the straight portion is smaller than an outer diameter D2 of the grommet in a state in which the diameter-reducing member is not fitted thereto.

8. The gas sensor according to claim 2, wherein
the diameter-reducing member has, at an inner surface thereof, a taper portion whose diameter expands toward a rear edge, and a straight portion located on a front end side relative to the taper portion, and
an inner diameter D1 of the straight portion is smaller than an outer diameter D2 of the grommet in a state in which the diameter-reducing member is not fitted thereto.
